(19) United States
(12) Patent Application Publication
(10) Pub. No.: US 2025/0174794 A1
(43) Pub. Date: May 29, 2025

(54) BATTERY PACK

(71) Applicant: HONDA MOTOR CO., LTD., Tokyo (JP)

(72) Inventors: Daigo KOMATSU, Tokyo (JP); Keiji TAKEUCHI, Tokyo (JP)

(73) Assignee: HONDA MOTOR CO., LTD., Tokyo (JP)

(21) Appl. No.: 18/947,747

(22) Filed: Nov. 14, 2024

(30) Foreign Application Priority Data
Nov. 24, 2023 (JP) 2023-199090

(51) Int. Cl. H01M 50/242; H01M 50/209; H01M 50/271

(52) U.S. Cl. CPC H01M 50/242; H01M 50/209; H01M 50/271

(57) ABSTRACT

A battery pack including: a plurality of stacked battery cells; and a case that accommodates the plurality of battery cells, in which a side wall of the case is provided with an opening in a stacking direction of plurality of the battery cells, the opening having a closed periphery, and a pressurization plate that presses the plurality of battery cells against the case in the stacking direction is attached to the opening.

### CROSS-REFERENCE TO RELATED APPLICATIONS

This application is based on and claims priority under 35 USC 119 from Japanese Patent Application No. 2023-199090 filed on Nov. 24, 2023, the entire content of which is incorporated herein by reference.

### TECHNICAL FIELD

The present invention relates to a battery pack.

### BACKGROUND ART

In recent years, researches and developments have been conducted on a secondary battery which contributes to improvement in energy efficiency in order to allow more people to have access to affordable, reliable, sustainable, and advanced energy.

For example, WO2023/068029 describes a power storage device that includes a power storage unit including a plurality of power storage elements each having a flat shape, and an exterior body that accommodates the power storage unit. In the power storage device of WO2023/068029, the power storage unit is inserted from a second opening formed at a position facing a side wall of the exterior body and is accommodated inside the exterior body, and then a second lid is welded to the exterior body to close the second opening. At this time, the second lid presses the plurality of power storage elements in an arrangement direction thereof via a spacer to compress the power storage unit.

The power storage device of WO2023/0680291 is of a cell-to-pack type in which a plurality of power storage elements are accommodated in an exterior body without being unitized or modularized, and is advantageous in terms of space efficiency. However, since the second opening is formed by not providing a side wall on an insertion opening side of the power storage unit in the exterior body, there is room for improvement in terms of impact resistance against an external impact.

An object of the present invention is to provide a battery pack that improves space efficiency and improves impact resistance against an external impact. This further contributes to improvement in energy efficiency.

### SUMMARY OF INVENTION

According to an aspect of the present invention, there is provided a battery pack including:
a plurality of stacked battery cells; and
a case that accommodates the plurality of battery cells, in which
a side wall of the case is provided with an opening in a stacking direction of plurality of the battery cells, the opening having a closed periphery, and
a pressurization plate that presses the plurality of battery cells against the case in the stacking direction is attached to the opening.

### BRIEF DESCRIPTION OF DRAWINGS

FIG. 1 is an external perspective view of a battery pack 10;

FIG. 2 is an exploded perspective view of the battery pack 10;

FIG. 3 is an exploded perspective view of a cell stack 30;

FIG. 4 is a cross-sectional view of a pressurization plate 28 in a state where a plurality of battery cells 40 and an end plate 31 are pressed;

FIG. 5 is an exploded perspective view of the battery pack 10 of a modification; and

FIG. 6 is a partial perspective view of the pressurization plate 28 of the modification.

### DESCRIPTION OF EMBODIMENTS

Hereinafter, an embodiment of a battery pack of the present invention will be described with reference to the accompanying drawings. In the following description, for convenience, a coordinate system including a front-rear direction, a left-right direction, and an upper-lower direction orthogonal to each other is used. In the drawings, a front side is denoted by Fr, a rear side is denoted by Rr, a left side is denoted by L, a right side is denoted by R, an upper side is denoted by U, and a lower side is denoted by D. However, these directions are not related to a direction when the battery pack is mounted on a device. For example, when the battery pack is mounted on a vehicle, an upper-lower direction of the battery pack may be oriented in a traveling direction of the vehicle or in a vehicle width direction when the battery pack is mounted on the vehicle.

### Battery Pack

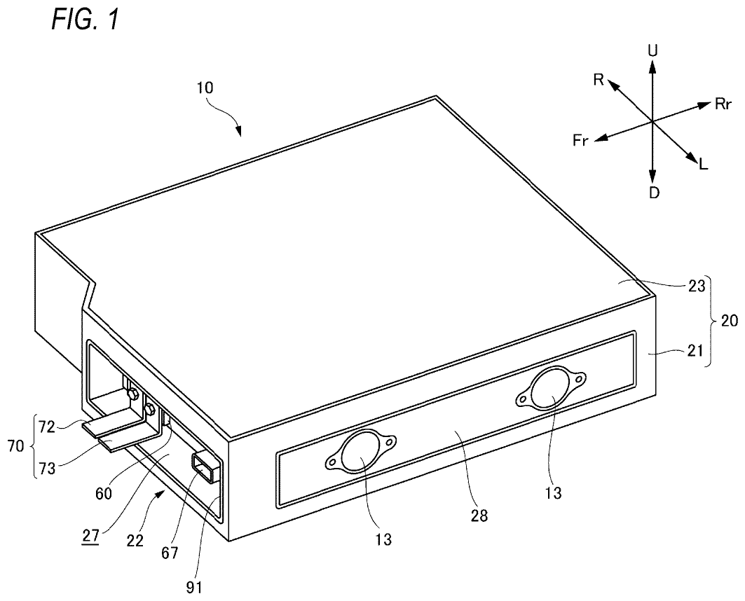

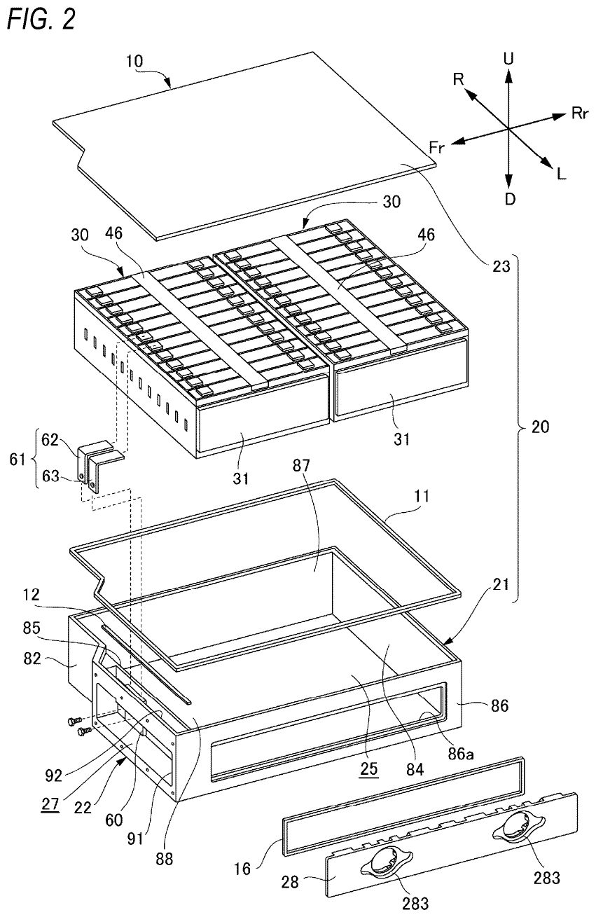

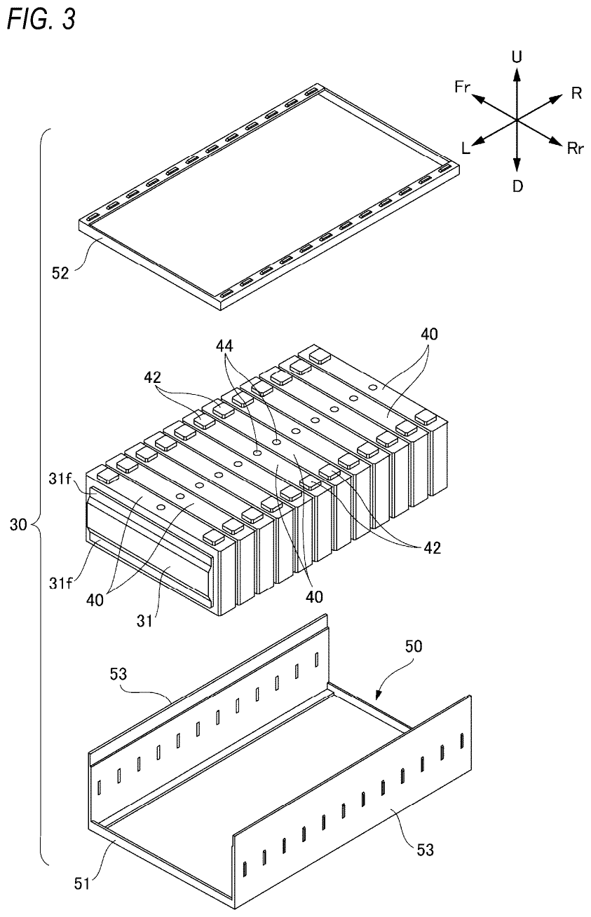

In a battery pack 10, as shown in FIGS. 1 and 2, two cell stacks 30 are arranged in a front-rear direction inside a box-shaped case 20. As shown in FIG. 3, the cell stack 30 includes a plurality of square battery cells 40 stacked in a left-right direction, and an end plate 31 disposed on one side in the left-right direction (left side in the present embodiment), which are temporarily fixed at a predetermined pressure by using a binder 50. A separator (not shown) may be disposed between adjacent battery cells 40. The binder 50 includes a rectangular lower restraining portion 51 surrounding a bottom surface of the cell stack 30, a rectangular upper restraining portion 52 surrounding an upper surface of the cell stack 30, and a pair of side restraining portions 53 sandwiching the cell stack 30 in the front-rear direction, and the lower restraining portion 51 and the pair of side restraining portions 53 are formed integrally. Another end plate, a separator, or the like may be disposed on the other side of the cell stack 30 in the left-right direction (right side in the present embodiment), and the battery cells 40 are not in direct contact with the case 20 on the other side. The cell stack 30 may not be configured such that the plurality of battery cells 40 are restrained by the binder 50. That is, the plurality of battery cells 40 may be directly stacked inside the case 20.

The end plate 31 includes flanges 3 1f at a lower end and an upper end, respectively, and the flanges 3 1f are restrained by the lower restraining portion 51 and the upper restraining portion 52, so that the end plate 31 is fixed to the plurality of battery cells 40.

The battery cells 40 are each, for example, a secondary battery such as a lithium ion battery. An upper surface of the battery cell 40 is provided with a pair of terminals 42 provided at both ends in the front-rear direction, which is a direction orthogonal to a stacking direction of the battery cells 40, and a safety valve 44 provided at a central portion in the front-rear direction and disposed between the pair of terminals 42. The pair of terminals 42 include a positive terminal and a negative terminal, and for example, the positive terminal is connected to the negative terminal of an adjacent battery cell 40 via a bus bar (not shown), and the negative terminal is connected to the positive terminal of an adjacent battery cell 40 via a bus bar (not shown), whereby the plurality of battery cells 40 are electrically connected in series. For example, in order to shorten a length of the bus bar, the plurality of battery cells 40 may be stacked such that orientations thereof in the front-rear direction are reversed alternately.

The safety valve 44 is a rupture valve, and prevents rupture of an outer can when an internal pressure of the battery cell 40 abnormally rises. If the internal pressure of the battery cell 40 abnormally rises, the safety valve 44 ruptures, and a gas in the battery cell 40 is discharged to the outside. By providing the safety valve 44 at the central portion of the battery cell 40 in the front-rear direction, the plurality of battery cells 40 can be aggregated at the same position in the front-rear direction even if the plurality of battery cells 40 are stacked such that the orientations thereof in the front-rear direction are reversed alternately.

Returning to FIG. 2, the battery cells 40 are provided with an exhaust duct 46 that connects the safety valves 44 of the plurality of battery cells 40 and that allows the gas discharged from the safety valves 44 to flow. For example, the exhaust duct 46 is implemented by a hood that covers the safety valves 44. The exhaust duct 46 extends in a direction in which the safety valves 44 are arranged, that is, in the stacking direction of the battery cells 40, and guides the gas toward a pressure relief valve 13 to be described later.

The case 20 includes a case body 21 whose upper side is open, and a case cover 23 that covers the opening of the case body 21. The case body 21 includes a front wall 82 and a rear wall 84 that extend in the left-right direction, a left wall 86 that connects left ends of the front wall 82 and the rear wall 84, a right wall 87 that connects right ends of the front wall 82 and the rear wall 84, and a bottom wall 88. A space surrounded by the front wall 82, the rear wall 84, the left wall 86, and the right wall 87 constitutes a cell accommodation space 25 for accommodating the cell stacks 30.

In the case body 21, upper ends of the front wall 82, the rear wall 84, the left wall 86, and the right wall 87 are continuously connected along an entire circumference.

The left wall 86 is provided with an opening 86a that allows the cell accommodation space 25 to communicate with the outside. The opening 86a is provided at a substantially central portion of the left wall 86 in an upper-lower direction and the front-rear direction, and a periphery thereof is closed.

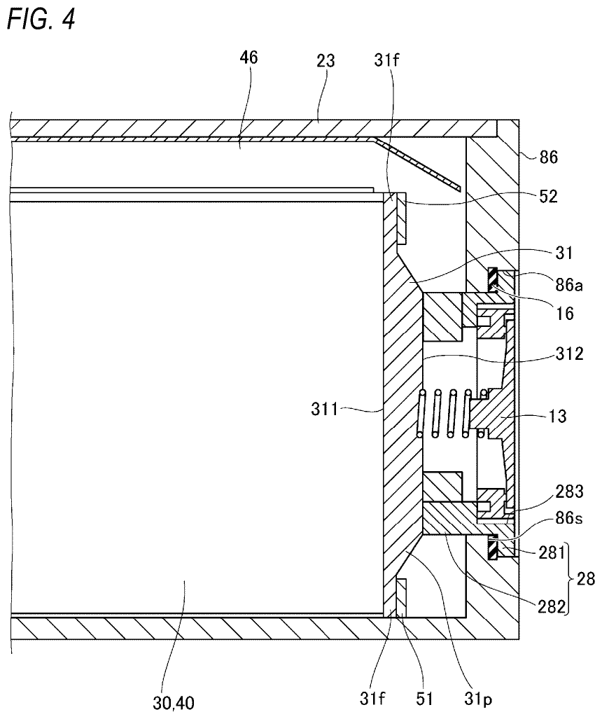

As shown in FIGS. 2 and 4, a pressurization plate 28 is attached to the opening 86a via a seal member 16 (for example, a rubber seal). By fixing the pressurization plate 28 to the left wall 86, the pressurization plate 28 presses the battery cells 40 against the case 20 in the stacking direction. More specifically, by fixing the pressurization plate 28 to the left wall 86, the pressurization plate 28 comes into contact with the end plates 31 of the two cell stacks 30 from the opening 86a. When the pressurization plate 28 presses the end plate 31 in the stacking direction, the plurality of battery cells 40 temporarily fixed by the binder 50 with a predetermined pressure are further pressurized in the stacking direction and held in the case 20. The pressurization plate 28 is fixed to the left wall 86 by welding such as friction stir welding.

As described above, in the battery pack 10, since the plurality of battery cells 40 can be held in the case 20 by being pressed by the pressurization plate 28 without being modularized, space efficiency and energy density can be improved. Since the periphery of the opening 86a is closed, it is possible to prevent a decrease in rigidity of the case 20 due to the provision of the opening 86a, and to improve impact resistance against an external impact, as compared with, for example, an opening whose periphery is not closed (for example, an opening having a shape in which the upper end of the left wall is open).

In addition, since the pressurization plate 28 faces the end plate 31 and presses the battery cells 40 against the case 20 via the end plate 31, it is possible to reduce an impact on the battery cell 40 when the impact is applied from the outside, as compared with a case where the pressurization plate 28 presses the battery cells 40 directly without using the end plate 31.

The end plate 31 includes the flanges 31f provided on a surface in contact with the battery cell 40, and a convex portion 31p in contact with the pressurization plate 28 and protruding toward the left wall 86. The end plate 31 is configured such that an area of a contact surface 311 (surface on a flange 31f side) with the battery cells 40 is larger than an area of a contact surface 312 (surface on a convex portion 31p side) with the pressurization plate 28. Accordingly, it is possible to prevent the battery cells 40 from being locally pressed.

The opening 86a is smaller than the contact surface 311 of the end plate 31 with the battery cell 40. Specifically, in each of the upper-lower direction and the front-rear direction, a length of the opening 86a are smaller than a length of the contact surface 311 of the end plate 31 with the battery cell 40. As described above, since the opening 86a is provided to be small, it is possible to further prevent the decrease in rigidity of the case 20 due to the provision of the opening 86a.

In addition, since the end plate 31 is provided integrally with the plurality of battery cells 40 by the binder 50, it is possible to prevent displacement with respect to the battery cells 40 even when the end plate 31 is pressed by the pressurization plate 28.

As shown in FIGS. 1 and 4, the pressurization plate 28 is provided with two pressure relief valves 13 communicating with the cell accommodation space 25. A flow path (not shown) that allows the exhaust duct 46 to communicate with the pressure relief valve 13 is formed in the pressurization plate 28, and when an internal pressure of the cell accommodation space 25 abnormally rises due to the gas generated from the safety valve 44 of the battery cell 40, the pressure relief valves 13 are opened to discharge the gas in the case 20 to the outside.

Here, the pressurization plate 28 and the opening 86a will be described in more detail.

As shown in FIG. 4, the pressurization plate 28 includes a flange 281 facing a peripheral edge of the opening 86a of the left wall 86, a convex portion 282 protruding from the opening 86a to an inside of the case 20 and pressing the battery cells 40 via the end plate 31, and two openings 283 to which the pressure relief valves 13 are attached, respectively. The pressurization plate 28 is fixed to the left wall 86 of the case body 21 at the flange 281, and the convex portion 282 protrudes from the opening 86a to the inside of the case 20 to press the plurality of battery cells 40 via the end plate 31.

In the opening 86a, a step 86s is formed at an outer position of the case 20, and the pressurization plate 28 is fixed to the left wall 86 such that the flange 281 is fitted into the step 86s via the seal member 16. At this time, the flange 281 of the pressurization plate 28 is provided at an inside with respect to an outer surface of the left wall 86, and the pressurization plate 28 does not protrude from an outside of the left wall 86. With this configuration, when an impact is applied from a left side of the case 20, a large amount of impact can be received by the left wall 86 before the impact is applied to the pressurization plate 28, so that it is possible to reduce the impact applied to the battery cells 40 via the pressurization plate 28 and the end plate 31.

In addition, since the seal member 16 is provided between the step 86s and the flange 281 of the pressurization plate 28, a waterproof property of the case 20 can be ensured. In particular, in the present embodiment, since the step 86s is provided at the peripheral edge of the opening 86a, the seal member 16 is easily disposed.

Returning to FIG. 2, an expanded portion 22 is formed forward of and leftward of the front wall 82 in a manner protruding further forward of the front wall 82. The expanded portion 22 has a space formed inside, and has a first opening 91 provided in a front surface and a second opening 92 provided in an upper surface. The internal space of the expanded portion 22 is provided with a terminal block 60 connected with a lead-out conductive member 70, and forms an output terminal accommodation space 27. Electrically connected in the terminal block 60 are a terminal (output terminal) of an output conductive member 61 extending from the cell accommodation space 25 to the output terminal accommodation space 27, and a terminal of the lead-out conductive member 70 entering the output terminal accommodation space 27 from the first opening 91. The output conductive member 61 includes a positive-side bus bar 62 and a negative-side bus bar 63 respectively extending from a positive-side output terminal and a negative-side output terminal of the two cell stacks 30 electrically connected in series. The lead-out conductive member 70 includes, for example, a positive-side bus bar 72 and a negative-side bus bar 73 respectively connected to external positive terminal and negative terminal.

As described above, the inside of the case 20 has the cell accommodation space 25 that accommodates the two cell stacks 30, and the output terminal accommodation space 27 disposed forward of and leftward of the cell accommodation space 25 and connected with the lead-out conductive member 70. The number of the cell stacks 30 accommodated in the cell accommodation space 25 may be one or three or more.

A region of the front wall 82 that separates the cell accommodation space 25 from the output terminal accommodation space 27 (hereinafter, this portion is referred to as a partition wall 85) is lower in height than the other regions. The positive-side bus bar 62 and the negative-side bus bar 63 extend from above the partition wall 85 to the output terminal accommodation space 27, and are fixed to the terminal block 60 provided in the output terminal accommodation space 27.

As shown in FIG. 1, the output terminal accommodation space 27 is provided with a signal line connector 67. The signal line connector 67 is connected with a signal line via a through hole that allows the cell accommodation space 25 to communicate with the output terminal accommodation space 27.

As shown in FIG. 2, the case cover 23 is attached to the upper ends of the front wall 82, the left wall 86, the right wall 87, and the rear wall 84 of the case body 21 via a first seal member 11 (for example, a rubber seal). The case cover 23 is fixed to an upper surface of the case body 21 by welding such as friction stir welding, for example. A gap between the partition wall 85 and the case cover 23 is provided with a second seal member 12 (for example, a foamed seal), and the cell accommodation space 25 is sealed from the outside by the first seal member 11 and the second seal member 12. By sealing the cell accommodation space 25 from the outside, it is possible to prevent entry of foreign matters into the cell accommodation space 25, thereby preventing deterioration of the battery cells 40. It is preferable to further provide a seal member such as a foamed seal in a gap between the through hole provided in the partition wall 85 and the signal line.

The battery pack 10 configured as described above does not include an auxiliary device such as an ECU or a junction box that accommodates a comparator, a fuse, and the like. Therefore, if the battery pack 10 is used alone, the battery pack 10 may be connected to a junction box and/or an ECU. If a plurality of battery packs 10 are used, the battery packs 10 may be electrically connected to each other in a connection box, and the connection box may be connected to a junction box and/or an ECU. Further, a junction box and/or an ECU may be incorporated in a connection box, and the plurality of battery packs 10, the junction box and/or the ECU may be connected in the connection box.

### Modification of Battery Pack

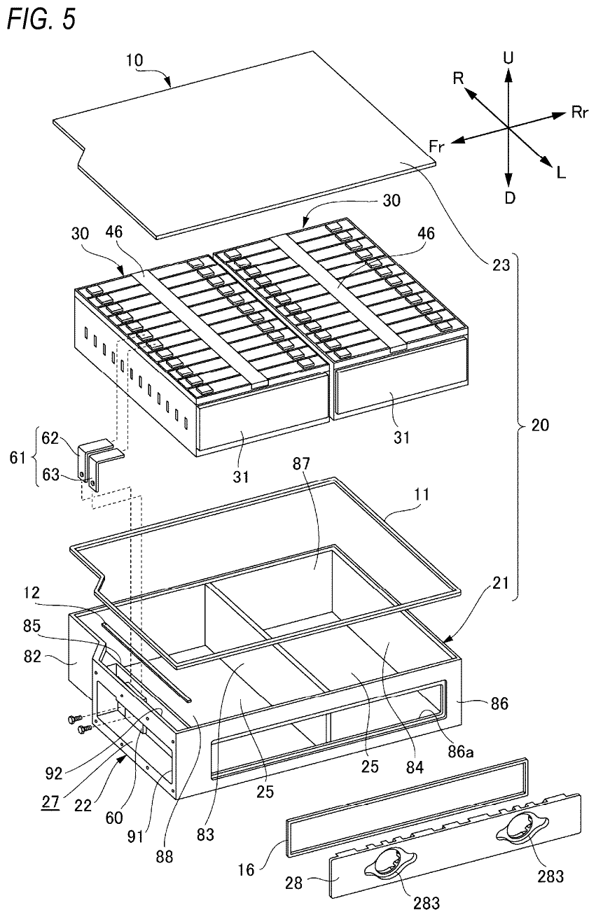

As shown in FIG. 5, the case body 21 may further include a central wall 83 extending in the left-right direction between the front wall 82 and the rear wall 84. In this case, the cell stacks 30 are accommodated between the front wall 82 and the central wall 83, and between the central wall 83 and the rear wall 84, respectively.

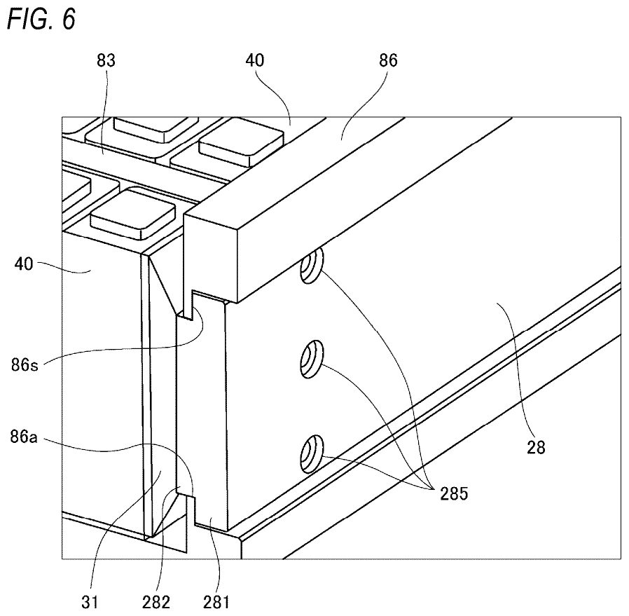

In the above-described embodiment, the pressurization plate 28 is attached to the opening 86a of the left wall 86 by welding such as friction stir welding, but the present invention is not limited thereto. For example, as shown in FIG. 6, bolt insertion holes 285 may be provided in the pressurization plate 28 and the left wall 86, and bolts (not shown) passing through the bolt insertion holes 285 may be fastened respectively to bolt holes provided in the central wall 83 or the like to attach the pressurization plate 28 to the left wall 86.

Although the embodiment of the present invention has been described above with reference to the accompanying drawings, it is needless to say that the present invention is not limited to the embodiment. It is apparent that those skilled in the art can conceive of various modifications and alterations within the scope described in the claims, and it is understood that such modifications and alterations naturally fall within the technical scope of the present invention. In addition, the constituent elements in the above embodiment may be freely combined without departing from the gist of the invention.

For example, in the above-described embodiment, the end plate 31 is disposed on only one side in the stacking direction of the plurality of battery cells 40 (left side in the embodiment), but may be disposed on both sides in the stacking direction of the plurality of battery cells 40.

In the present specification, at least the following matters are described. In the parentheses, the corresponding constituent elements and the like in the above embodiment are shown as examples, but the present invention is not limited thereto.

(1) A battery pack (battery pack 10) including:
a plurality of stacked battery cells (battery cells 40); and
a case (case 20) that accommodates the plurality of battery cells, in which
a side wall (left wall 86) of the case is provided with an opening (opening 86a) in a stacking direction of the plurality of battery cells, the opening having a closed periphery, and
a pressurization plate (pressurization plate 28) that presses the plurality of battery cells against the case in the stacking direction is attached to the opening.

According to (1), since the plurality of battery cells can be held in the case by being pressed by the pressurization plate without being modularized, space efficiency of the battery pack can be improved. In addition, since the periphery of the opening of the case in which the pressurization plate is provided is closed, it is possible to prevent a decrease in rigidity of the case due to the provision of the opening, and to improve impact resistance against an external impact.

(2) The battery pack according to (1), further including:
an end plate (end plate 31) that is provided at an end of the plurality of battery cells in the stacking direction and faces the pressurization plate, in which
the pressurization plate presses the plurality of battery cells against the case via the end plate.

According to (2), by providing the end plate between the battery cells and the pressurization plate, it is possible to reduce an impact on the battery cells as compared with a case where the pressurization plate directly presses the battery cells.

(3) The battery pack according to (2), in which
in the end plate, an area of a contact surface (contact surface 311) with the plurality of battery cells is larger than an area of a contact surface (contact surface 312) with the pressurization plate.

According to (3), by increasing the contact surface between the end plate and the battery cells, it is possible to prevent the battery cells from being locally pressed by the pressurization plate.

(4) The battery pack according to (2) or (3), in which
the opening is smaller than a contact surface (contact surface 311) with the plurality of battery cells among surfaces of the end plate.

According to (4), by making the opening small, it is possible to prevent the decrease in rigidity of the case due to the provision of the opening.

(5) The battery pack according to any one of (2) to (4), in which
the end plate is provided integrally with the plurality of battery cells by a restraining member (binder 50).

According to (5), it is possible to prevent the end plate from being displaced with respect to the battery cells.

(6) The battery pack according to any one of (1) to (5), in which
the pressurization plate includes
a flange (flange 281) facing a peripheral edge of the opening, and
a convex portion (convex portion 282) protruding from the opening to an inside of the case and pressing the plurality of battery cells against the case.

According to (6), the battery cells can be pressed by the convex portion of the pressurization plate protruding from the opening to the inside of the case.

(7) The battery pack according to (6), in which
the peripheral edge of the opening is provided with a step (step 86s) into which the flange of the pressurization plate is fitted and which faces the flange of the pressurization plate, and
the flange of the pressurization plate is provided at an inside with respect to an outer surface of the side wall of the case.

According to (7), since the side wall of the case receives a large amount of impact from outside the case, it is possible to reduce the impact applied to the battery cells.

(8) The battery pack according to (7), in which
a seal member (seal member 16) is provided between the step of the case and the flange of the pressurization plate.

According to (8), even if the pressurization plate is provided in the opening of the side wall of the case, a waterproof property of the case can be ensured.

(9) The battery pack according to any one of (1) to (8), in which
the case includes a case body (case body 21) having the side wall and accommodating the battery cells, and a case cover (case cover 23) covering the case body from above,
an upper end of the side wall of the case body is continuously connected along an entire circumference, and
the case cover is connected to the upper end of the case body via a seal member (first seal member 11).

According to (9), since the upper end of the side wall of the case body is continuously provided along the entire circumference, a rigidity of the case body can be increased. In addition, since the case cover is connected to the upper end of the case body via the seal member, the waterproof property of the case can be ensured.

(10) The battery pack according to any one of (1) to (9), in which
the pressurization plate is provided with a pressure relief valve (pressure relief valve 13) configured to exhaust, to an outside of the case, a gas discharged from a safety valve (safety valve 44) provided in each of the plurality of battery cells.

According to (10), the gas discharged to the inside of the case due to thermal runaway can be exhausted to the outside of the case, and a pressure inside the case can be released. Thus, damage to the case can be prevented.

What is claimed is:

1. A battery pack comprising:
a plurality of stacked battery cells; and
a case that accommodates the plurality of battery cells, wherein
a side wall of the case is provided with an opening in a stacking direction of plurality of the battery cells, the opening having a closed periphery, and
a pressurization plate that presses the plurality of battery cells against the case in the stacking direction is attached to the opening.

2. The battery pack according to claim 1, further comprising:
an end plate that is provided at an end of the plurality of battery cells in the stacking direction and faces the pressurization plate, wherein
the pressurization plate presses the plurality of battery cells against the case via the end plate.

3. The battery pack according to claim 2, wherein
in the end plate, an area of a contact surface with the plurality of battery cells is larger than an area of a contact surface with the pressurization plate.

4. The battery pack according to claim 2, wherein
the opening is smaller than a contact surface with the plurality of battery cells among surfaces of the end plate.

5. The battery pack according to claim 2, wherein
the end plate is provided integrally with the plurality of battery cells by a restraining member.

6. The battery pack according to claim 1, wherein
the pressurization plate includes:
a flange facing a peripheral edge of the opening; and
a convex portion protruding from the opening to an inside of the case and pressing the plurality of battery cells against the case.

7. The battery pack according to claim 6, wherein
the peripheral edge of the opening is provided with a step into which the flange of the pressurization plate is fitted and which faces the flange of the pressurization plate, and
the flange of the pressurization plate is provided at an inside with respect to an outer surface of the side wall of the case.

8. The battery pack according to claim 7, wherein
a seal member is provided between the step of the case and the flange of the pressurization plate.

9. The battery pack according to claim 1, wherein
the case includes a case body having the side wall and accommodating the battery cells, and a case cover covering the case body from above,
an upper end of the side wall of the case body is continuously connected along an entire circumference, and
the case cover is connected to the upper end of the case body via a seal member.

10. The battery pack according to claim 1, wherein
the pressurization plate is provided with a pressure relief valve configured to exhaust, to an outside of the case, a gas discharged from a safety valve provided in each of the plurality of battery cells.
